(19) United States
(12) Patent Application Publication
(10) Pub. No.: US 2024/0343239 A1
(43) Pub. Date: Oct. 17, 2024

(54) ELECTRIC BRAKING DEVICE

(71) Applicant: ADVICS CO., LTD., Kariya-shi (JP)

(72) Inventor: Naru SUGIMOTO, Kariya-shi (JP)

(73) Assignee: ADVICS CO., LTD., Kariya-shi (JP)

(21) Appl. No.: 18/291,296

(22) PCT Filed: Aug. 10, 2022
(86) PCT No.: PCT/JP2022/030586

§ 371 Date: Jan. 23, 2024

(30) Foreign Application Priority Data
Aug. 11, 2021 (JP) 2021-131434

(51) Int. Cl. B60T 13/74; F16D 55/226; F16D 65/18; F16D 121/24; F16D 125/40

(52) U.S. Cl. CPC B60T 13/746; F16D 55/226; F16D 65/18; F16D 2121/24; F16D 2125/40; F16D 2200/0056

(57) ABSTRACT

The electric braking device includes a nut that is a rotating member that rotates upon receiving the rotation of an electric motor, a screw shaft that is a linear motion member that linearly moves in accordance with the rotation of the nut, and a piston that linearly moves together with the screw shaft to press a brake pad against a brake rotor. The piston is provided with a socket hole that is a spherical hole, and the screw shaft is provided with a spherical ball head that fits into the socket hole. With the ball head fitted into the socket hole, the piston is pivotably coupled to the screw shaft.

### TECHNICAL FIELD

The present disclosure relates to an electric braking device that generates braking force by pressing friction members against a brake rotor, using rotation of an electric motor as power.

### BACKGROUND ART

As an example of the electric braking device as described above, a device disclosed in Patent Literature 1 is known. The electric braking device disclosed in Patent Literature 1 includes an electric motor, a linear motion conversion mechanism, and a piston. The linear motion conversion mechanism includes a rotating member that rotates by being driven by the electric motor, and a linear motion member that moves linearly in accordance with the rotation of the rotating member. The linear motion of the linear motion member then moves the piston, thereby causing the piston to apply pressure to friction members. As a result, the friction members are pressed against the brake rotor. Note that the electric braking device disclosed in Patent Literature 1 is configured to electrically operate as a parking brake, and to hydraulically operate as a service brake.

### CITATIONS LIST

### Patent Literature

Patent Literature 1: JP 2011-213205 A

### BRIEF SUMMARY

### Technical Problems

An electric braking device that electrically operates as a service brake is currently under development. Such an electric braking device is required to move the piston also in the direction opposite to the direction for pressing the friction members, by being driven by the electric motor. Therefore, in such a case, it is necessary to couple the piston to the linear motion member of the linear motion conversion mechanism in such a manner that the piston moves integrally with the linear motion member.

At the same time, if the electric braking device generates strong braking force, a brake caliper, to which the friction members and the linear motion conversion mechanism are fixed, may deform. If the brake caliper deforms, the piston becomes tilted, and brought into partial contact with the friction member, and the friction member may wear out unevenly.

### Solutions to Problems

An electric braking device for solving the problems described above generates braking force by pressing friction members against a brake rotor using rotation of an electric motor as power. The electric braking device includes a rotating member that rotates upon receiving the rotation of the electric motor, a linear motion member that linearly moves in a direction along a rotation axis of the rotating member in accordance with the rotation of the rotating member, and a piston that linearly moves together with the linear motion member to press the friction members against the brake rotor. The piston in the electric braking device is pivotably coupled to the linear motion member.

In the electric braking device, the piston is pivotably coupled to the linear motion member. Because the piston pivots with respect to the linear motion member, even when the rotating member and the linear motion member become tilted, a change in the condition in the contact between the piston and the friction member is suppressed. Therefore, in the electric braking device, uneven wearing of the friction member is suppressed.

### BRIEF DESCRIPTION OF DRAWINGS

FIG. 1 is a cross-sectional view of an electric braking device according to one embodiment.

FIG. 2 is a diagram illustrating electric braking device according to the embodiment, while braking force is being generated.

FIG. 3 is a diagram illustrating an electric braking device according to a comparative example, including a piston integrally coupled to a screw shaft, while braking force is being generated.

FIG. 4 is a cross-sectional view illustrating an example of a structure for preventing disengagement of a ball head.

FIG. 5 is a cross-sectional view illustrating another example of the structure for preventing disengagement of the ball head.

FIG. 6 is a cross-sectional view illustrating an example of a structure for restricting the rotation of a screw shaft.

FIG. 7 is a cross-sectional view taken along line 7-7 in FIG. 6.

FIG. 8 is a cross-sectional view illustrating another example of the structure for restricting the rotation of the screw shaft.

FIG. 9 is a cross-sectional view illustrating still another example of the structure for restricting the rotation of the screw shaft.

FIG. 10 is a cross-sectional view of a linear motion conversion mechanism and a piston in an electric braking device according to a modification.

FIG. 11 is a cross-sectional view illustrating a structure for coupling a piston and a screw shaft in an electric braking device according to another modification.

### DESCRIPTION OF EMBODIMENT

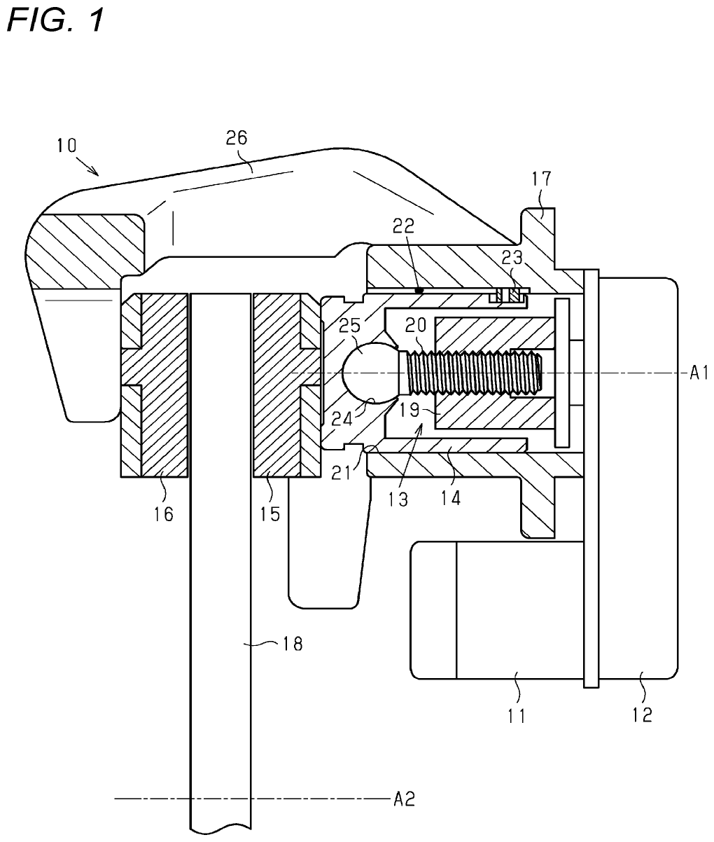

One embodiment for embodying an electric control device will now be explained with reference to FIGS. 1 to 9.

### <Configuration of Electric Control Device 10>

As illustrated in FIG. 1, the electric braking device 10 includes an electric motor 11, a decelerator mechanism 12, a linear motion conversion mechanism 13, a piston 14, brake pads 15, 16, and a brake caliper 17. The electric motor 11, the decelerator mechanism 12, the linear motion conversion mechanism 13, the piston 14, and the brake pads 15, 16 are mounted on the brake caliper 17. By fixing the brake caliper 17 to a vehicle body, the electric braking device 10 is assembled to a vehicle.

The electric braking device 10 generates braking force by pressing the brake pads 15, 16 that are friction members, against the brake rotor 18 rotating together with the wheels, using the rotation of the electric motor 11 as power. The brake pads 15, 16 are mounted on the brake caliper 17 in a manner facing each other with the brake rotor 18 interposed therebetween, in the condition assembled to the vehicle. In the following description, a portion of the brake caliper 17 connecting the positions for mounting the brake pad 15 and the other brake pad 16 will be referred to as a beam portion 26 of the brake caliper 17.

The electric motor 11 and the decelerator mechanism 12 are mounted on the outside of the brake caliper 17. The electric motor 11 generates a rotational force, using external power supply. The decelerator mechanism 12 decelerates the rotation of the electric motor 11, and transmits the rotation to the linear motion conversion mechanism 13. In the electric braking device 10 according to the present embodiment, a reduction gear mechanism including two or more gears with different numbers of teeth is used as the decelerator mechanism 12.

The linear motion conversion mechanism 13 and the piston 14 are housed inside a cylinder 21 provided in the brake caliper 17. The linear motion conversion mechanism 13 converts the rotation transmitted via the decelerator mechanism 12 into a linear motion. In the present embodiment, a sliding screw mechanism including a nut 19 and a screw shaft 20 is used as the linear motion conversion mechanism 13. The nut 19 rotates upon receiving the rotation of the electric motor 11 via the decelerator mechanism 12, and the screw shaft 20 moves linearly in accordance with the rotation of the nut 19. The nut 19 is installed inside the cylinder 21 in a manner supported rotatably. The screw shaft 20 is supported in a linearly movable manner, with respect to the nut 19, along a rotation axis A1 of the nut 19. One end of the screw shaft 20 is coupled to the piston 14. The structure for coupling the piston 14 and the screw shaft 20 will be explained later in detail. In the present embodiment, the nut 19 of the linear motion conversion mechanism 13 corresponds to the rotating member, and the screw shaft 20 of the linear motion conversion mechanism 13 corresponds to the linear motion member. The brake caliper 17 is assembled to the vehicle in such a manner that the rotation axis A1 of the nut 19, that is, the direction of the linear motion of the screw shaft 20 is matched with a direction perpendicular to the friction surfaces of the brake rotor 18. In other words, the brake caliper 17 is assembled to the vehicle in such a manner that the rotation axis A1 of the nut 19 extends in parallel with a rotation axis A2 of the brake rotor 18.

The piston 14 is housed inside the cylinder 21, movably along the direction of the linear movement of the screw shaft 20. A groove 22 extending in the direction of the movement of the screw shaft 20 is provided on a wall surface of the cylinder 21. An engagement member 23 that engages with the groove 22 is attached to the piston 14. The engagement of the engaging member 23 with the groove 22 restricts the rotation of the piston 14 about the rotation axis A1.

In such an electric braking device 10, when the electric motor 11 is rotated, the decelerator mechanism 12 decelerates the rotation, and transmits the resultant rotation to the nut 19 in the linear motion conversion mechanism 13. With this, the screw shaft 20 moves linearly as the nut 19 is rotated. The direction in which the screw shaft 20 moves linearly is switched depending on the direction in which the electric motor 11 is rotated. In the following description, among the directions of the linear movement of the screw shaft 20, the direction toward the side where the brake pads 15, 16 are located, as viewed from the piston 14, will be referred to as a pressing direction, and the direction opposite thereto will be referred to as a depressurizing direction. When the electric motor 11 is rotated to cause the screw shaft 20 as well as the piston 14 to move in the pressing direction, the piston 14 is brought into contact with the brake pad 15, and presses the brake pad 15. The other brake pad 16 positioned on the opposite side of the brake rotor 18 also receives this pressing force. With the two brake pads 15, 16 thus applying pressure to the respective surfaces of the brake rotor 18, the electric braking device 10 generates braking force for the wheel.

When the electric motor 11 is rotated in the direction reverse to the direction for generating the braking force, the screw shaft 20 moves in the depressurizing direction together with the piston 14. With this movement, the pressing force exerted by the brake pads 15, 16 against the brake rotor 18 is released, so that the electric braking device 10 stops generating the braking force.

### <Structure Connecting Piston 14 and Screw Shaft 20>

A structure for coupling the piston 14 and the screw shaft 20 in the electric braking device 10 will now be explained in detail. As illustrated in FIG. 1, a socket hole 24 internal of which delineates a concave spherical surface is provided at the position where the screw shaft 20 is coupled to the piston 14. One end of the screw shaft 20 has a spherical ball head 25, on the side to be coupled to the piston 14. The ball head 25 has a sphere diameter equal to the sphere diameter of the socket hole 24. The ball head 25 is fitted into the socket hole 24, and, in this manner, the piston 14 is pivotably coupled to the screw shaft 20.

### Operation and Effect Achieved by Embodiment

An operation and effect achieved by the electric braking device 10 according to the present embodiment will now be explained.

As described above, the linear motion conversion mechanism 13 is assembled in such a manner that the rotation axis A1 of the nut 19, that is, the direction in which the screw shaft 20 moves linearly, extends perpendicularly to the friction surfaces of the brake rotor 18. In this arrangement, the direction in which the piston 14 presses the brake pad 15, and consequently, the direction in which both of the brake pads 15, 16 press the brake rotor 18 extends perpendicularly to the friction surfaces of the brake rotor 18. As long as this positioning is maintained, the brake pads 15, 16 are not brought into partial contact with the brake rotor 18, so that uneven wearing of the brake pads 15, 16 is suppressed.

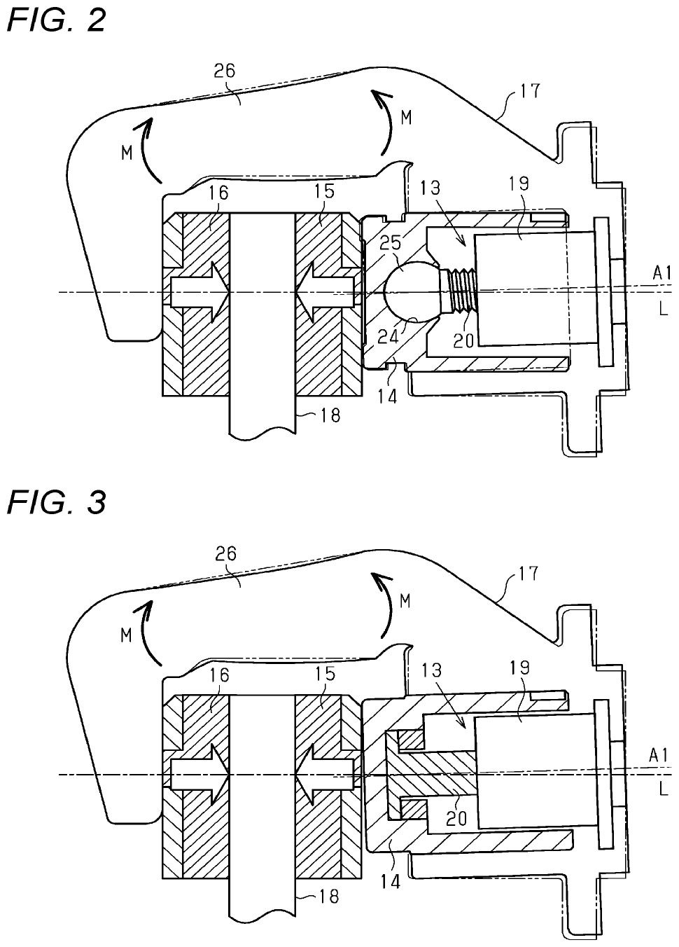

FIG. 2 illustrates the electric braking device 10 generating the braking force. As described above, the electric braking device 10 generates the braking force by causing the two brake pads 15, 16 to press the brake rotor 18 therebetween. At this time, the brake caliper 17 receives reaction forces in directions in which the brake pads 15, 16 are pushed away from each other, at the positions where the brake pads 15, 16 are mounted. Therefore, when the electric braking device 10 generates strong braking force, the beam portion 26 of the brake caliper 17, connecting points where both the brake pads 15, 16 are mounted, may become deformed and warped by receiving bending moments M. In FIG. 2, a two-dot chain line indicates the shape of the brake caliper 17 before deformation, and a solid line indicates the shape after the deformation. When the brake caliper 17 deforms in this manner, the rotation axis A1 of the nut 19, that is, the direction of the linear motion of the screw shaft 20 becomes tilted, with respect to the direction perpendicular to the friction surfaces of the brake rotor 18. A straight line L illustrated in FIGS. 2 and 3, to be described later, indicates the position of the rotation axis A1 of the nut 19 before the brake caliper 17 deforms.

FIG. 3 illustrates a condition in which the braking force is being generated by the electric braking device in which the piston 14 is integrally fixed with the screw shaft 20. In such a case, when the rotation axis A1 of the nut 19 becomes tilted with respect to the direction perpendicular to the friction surfaces of the brake rotor 18, due to the deformation of the brake caliper 17, the piston 14 also becomes tilted. As a result, the piston 14 is brought into partial contact with the brake pad 15, and the brake pad 15 wears out unevenly.

By contrast, in the electric braking device 10 according to the present embodiment, the piston 14 is pivotably coupled to the screw shaft 20. Therefore, even if the rotation axis A1 of the nut 19 becomes tilted with respect to the direction perpendicular to the friction surfaces of the brake rotor 18, as illustrated in FIG. 2, the piston 14 is pivoted with respect to the screw shaft 20, to maintain an appropriate contact with the brake pad 15. In other words, the piston 14 is pivotably coupled to the screw shaft 20 so as to maintain the contact between a pressed surface of the brake pad 15 and the piston 14 even when the brake caliper 17 deforms, in the manner described above. The pressed surface herein is a surface of the brake pad 15 that receives pressing force of the piston 14. Therefore, with the electric braking device 10 according to the present embodiment, it is possible to suppress the brake pad 15 from being worn out unevenly.

### <Regarding Structure for Preventing Disengagement of Ball Head 25>

In the electric braking device 10, when the pressing force of the piston 14 against the brake pad 15 is released, the screw shaft 20 moves in the depressurizing direction. In such an electric braking device 10, it is necessary to couple the screw shaft 20 and the piston 14 in such a manner that the ball head 25 of the screw shaft 20 does not come out of the socket hole 24 when the screw shaft 20 moves in the depressurizing direction. Note that the force applied to the portion coupling the screw shaft 20 and the piston 14 when the screw shaft 20 moves in the depressurizing direction is only the force caused by the sliding resistance of the piston 14 with respect to the cylinder 21. This force is very small compared with the force applied to the coupled portion when the screw shaft 20 presses the piston 14 to generate the braking force.

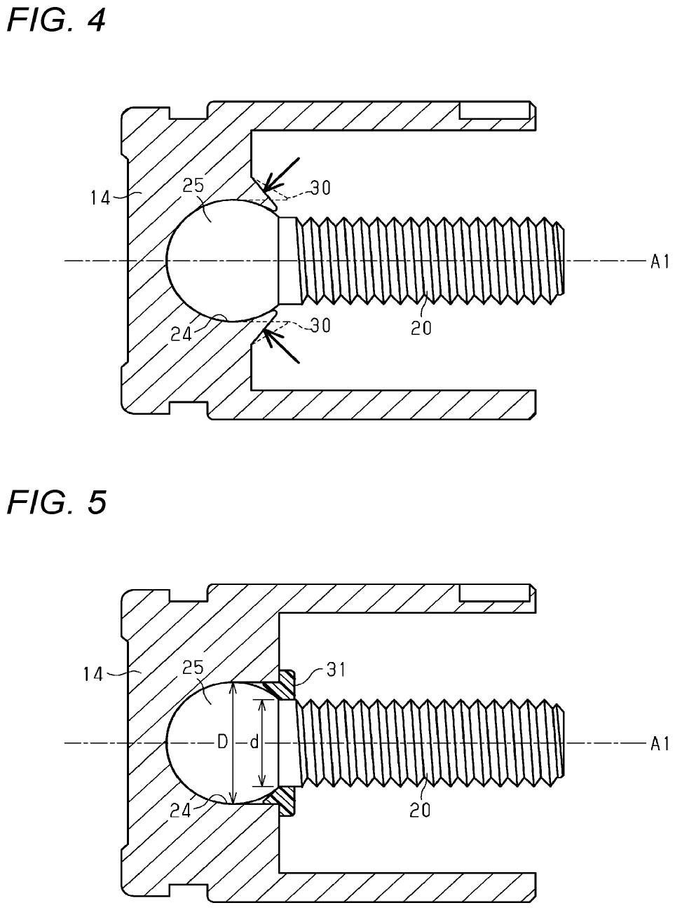

FIG. 4 illustrates an example of a structure for preventing disengagement of the ball head 25. FIG. 4 illustrates a cross-sectional structure of the piston 14 taken along a plane including the rotation axes A1 and A2 of the nut 19 and the brake rotor 18. In the structure illustrated in FIG. 4, the socket hole 24 has such a shape that the ball head 25 can be inserted therein, before the screw shaft 20 is coupled. Along the opening of the socket hole 24, a foldable flange 30, indicated by dotted lines in the drawing, is provided. After the ball head 25 is inserted into the socket hole 24, the foldable flange 30 is bent inwards toward the socket hole 24 by swaging. By swaging, the opening of the socket hole 24 is made smaller to a diameter smaller than the spherical diameter of the ball head 25. In this manner, the ball head 25 is prevented from becoming disengaged.

FIG. 5 illustrates another example of a structure for preventing disengagement of the ball head 25. FIG. 5 illustrates a cross-sectional structure of the piston 14 taken along a plane including the rotation axes A1 and A2 of the nut 19 and the brake rotor 18. In the example illustrated in FIG. 5, the diameter of the opening of the socket hole 24 is the same as or slightly larger than the spherical diameter D of the ball head 25. After the ball head 25 is inserted into the socket hole 24, a cap 31 made of an elastic material such as rubber is fixed to the opening of the socket hole 24. The cap 31 has an annular shape, and is fixed to the opening of the socket hole 24 by passing the screw shaft 20 through the inner circumference of the cap. An inner diameter d of the cap 31 is smaller than the spherical diameter D of the ball head 25, so that the ball head 25 cannot pass through the inner circumference of the cap 31. Therefore, by fixing the cap 31 so as not to come out from the opening of the socket hole 24, by the force applied to the portion where the screw shaft 20 and the piston 14 are coupled, when the screw shaft 20 is moved in the depressurizing direction, it is possible to prevent the ball head 25 from becoming disengaged. In the example illustrated FIG. 5, the piston 14 is enabled to move pivotably with respect to the screw shaft 20 by elastic deformation of the cap 31 formed of an elastic material.

The ball head 25 may be prevented from becoming disengaged from the socket hole 24 by a structure other than those described above. For example, it is also possible to prevent the disengagement of the ball head 25 by setting the opening diameter of the socket hole 24 slightly smaller than the spherical diameter of the ball head 25 and press-fitting the ball head 25 into the socket hole 24.

### <Regarding Structure for Restricting the Rotation of Screw Shaft 20>

The electric braking device 10 uses a linear motion conversion mechanism 13 including the screw shaft 20 that moves linearly in accordance with the rotation of the nut 19. In such an electric braking device 10, it is necessary to provide a catch for preventing the screw shaft 20 from rotating so that the screw shaft 20 does not rotate when the nut 19 is rotated. In the electric braking device 10 according to the present embodiment, the piston 14 is disposed in a manner covering the circumference of the screw shaft 20. In the electric braking device 10 having its element thus arranged, it is difficult to provide a structure for preventing the rotation of the screw shaft 20 directly to the brake caliper 17. Therefore, preferably, a structure for restricting the rotation of the screw shaft 20 is provided at the portion where the screw shaft 20 is coupled with the piston 14, the rotation of which with respect to the brake caliper 17 is restricted.

By providing a recess and a protrusion to the coupled portion with the piston 14 in the following manner, it is possible to restrict the rotation of the screw shaft 20. In other words, a recess is provided to one of the screw shaft 20 and the piston 14, and a protrusion that is to be positioned inside the recess is provided to the other. In such a case, the range of relative rotation of the screw shaft 20 with respect to the piston 14 about the rotation axis A1 is restricted to the range in which the protrusion is movable inside the recess. Therefore, by providing the recess and the protrusion in such a manner that the relative rotation of the screw shaft 20 about the rotation axis A1 with respect to the piston 14 is restricted within a predetermined angle, it is possible to restrict the rotation of the screw shaft 20.

When the rotation restricting structure including the recess and the protrusion as described above is provided at the portion coupling the screw shaft 20 and the piston 14, the rotation restricting structure might impose a limit on the directions in which the piston 14 pivots with respect to the screw shaft 20. When strong braking force is generated and the brake caliper 17 deforms, to cause the rotation axis A1 of the nut 19 to tilt, as illustrated in FIG. 2, the rotation axis A1 tilts on a plane including the rotation axis A2 of the brake rotor 18 and the rotation axis A1 of the nut 19. In order to avoid partial contact of the piston 14 with the brake pad 15, when the rotation axis A1 is tilted on such a plane, it is necessary for the piston 14 to be enabled to pivot about a pivotal axis that is orthogonal to such a plane. Therefore, even when the directions in which the piston 14 pivots are limited by the rotation restricting structure, it is preferable to allow the piston 14 to pivot at least about a pivotal axis that is orthogonal to the plane. Therefore, it is preferable for the recess and the protrusion of the rotation restricting structure to be provided on the pivotal axis.

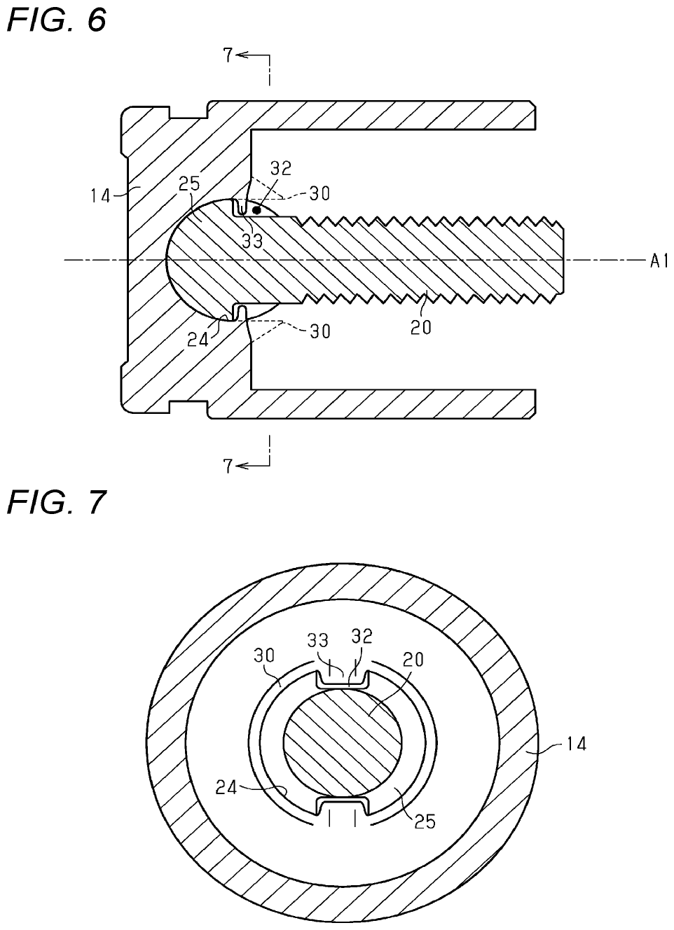

FIGS. 6 and 7 illustrate an example of the structure for restricting the rotation of the screw shaft 20. FIG. 6 illustrates a cross-sectional structure of the piston 14 and the screw shaft 20 taken along a plane perpendicular to a plane including the rotation axes A1, A2 of both of the nut 19 and the brake rotor 18, and also passing through the rotation axis A1 of the nut 19. FIG. 7 illustrates a cross-sectional structure taken along line 7-7 of FIG. 6. In the piston 14 illustrated in FIGS. 6 and 7, a foldable flange 30 similar to that illustrated in FIG. 4 is provided along the rim of the opening of the socket hole 24. This rotation restricting structure also includes recesses 32 provided to the ball head 25. The recesses 32 of the ball head 25 are provided to parts that come near the opening of the socket hole 24 when the screw shaft 20 is coupled to the piston 14. After the ball head 25 is inserted into the socket hole 24, the parts of the foldable flange 30 near the respective recesses 32 are folded into the respective recesses 32 by swaging. With the protruding and recessed relationship of the folded portions 33 and recesses 32, the structure for restricting the rotation of the rotation of the screw shaft 20 is achieved. In this example, the folded portions 33 of the folding portion 30 to be folded into the respective recesses 32 correspond to the protrusion that is to be positioned inside the recess 32. These folded portions 33 are swaged with some gap between each of these folded portions 33 and the corresponding recess 32. With this gap, the piston 14 is allowed to pivot with respect to the screw shaft 20. Such a rotation restricting structure also serves as a disengagement prevention structure for the ball head 25. In FIG. 7, four recesses 32 are provided in the ball head 25, but the number of recesses 32 may be any number that is one or more.

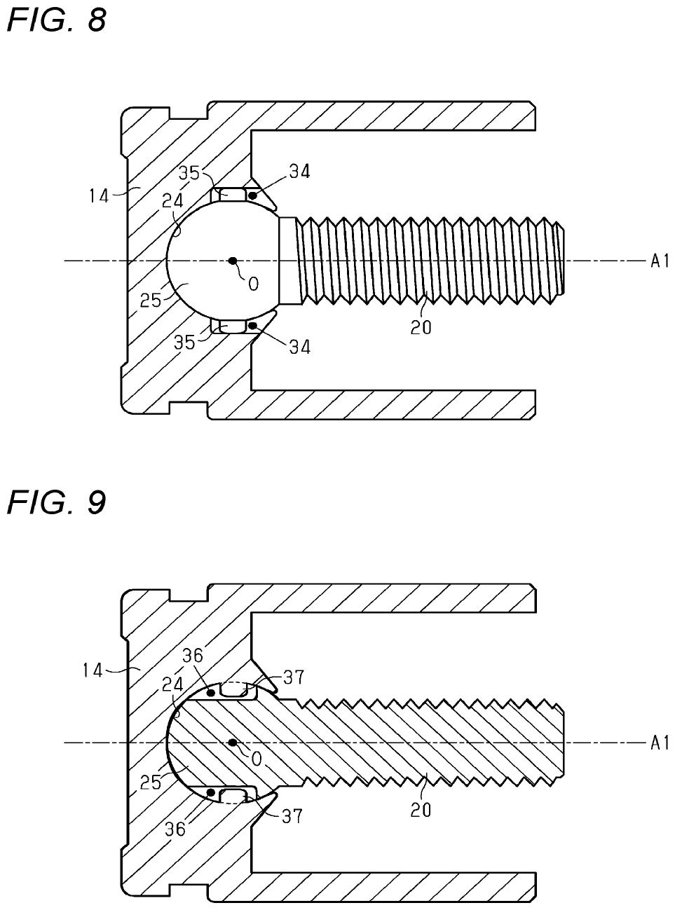

FIG. 8 illustrates another example of the rotation restricting structure of the screw shaft 20. FIG. 8 illustrates a cross-sectional structure of the piston 14 taken along a plane perpendicular to the plane including the rotation axes A1, A2 of both of the nut 19 and the brake rotor 18, and also passing through the rotation axis A1 of the nut 19. The rotation restricting structure in FIG. 8 includes grooves 34 provided on the inner wall of the socket hole 24, and protrusions 35 provided on the ball head 25. With the ball head 25 fitted in the socket hole 24, the protrusions 35 are disposed inside the respective grooves 34. In FIG. 8, two pairs of the groove 34 and the protrusion 35 are provided. The protrusion 35 has a cylindrical shape. The two protrusions 35 are positioned symmetrically to each other, with respect to the sphere center O of the convex spherical surface of the ball head 25. In such a rotation restricting structure, the piston 14 is allowed to pivot with respect to the screw shaft 20, about the central axis of the two cylindrical protrusions 35 as a pivot axis. In the configuration illustrated FIG. 8, a gap where the protrusion 35 is movable is ensured in the groove 34. The gap also allows the piston 14 to pivot with respect to the screw shaft 20.

FIG. 9 illustrates still another example of the rotation restricting structure of the screw shaft 20. FIG. 9 illustrates a cross-sectional structure of the piston 14 and the screw shaft 20 taken along a plane orthogonal to the plane including the rotation axis A1, A2 and passing through the rotation axis A1 of the nut 19. The rotation restricting structure illustrated in FIG. 9 includes grooves 36 provided on the ball head 25, and protrusions 37 provided on the wall surface of the socket hole 24. By providing the grooves 36 to the ball head 25 and the protrusions 37 on the socket hole 24, too, as described above, the rotation of the screw shaft 20 can be restricted, in the same manner as in the example illustrated in FIG. 8. In the rotation restricting structure illustrated in FIGS. 8 and 9, the groove 34, 36 corresponds to the recess, and the protrusion 35, 37 corresponds to the protrusion.

### Other Embodiments

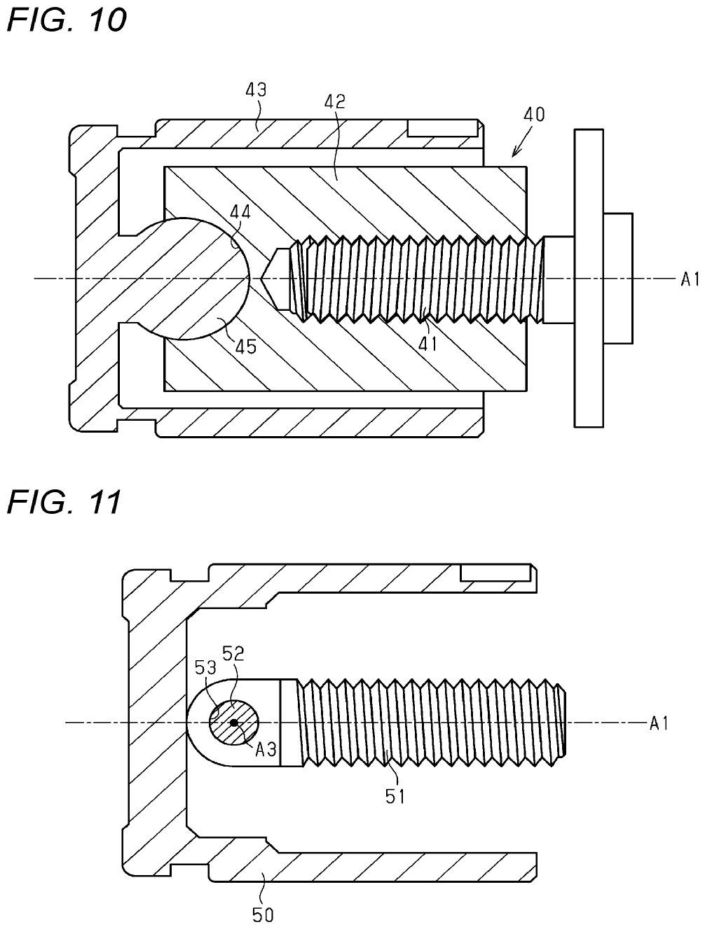

Following modifications of the present embodiment are still possible. The present embodiment and the following modifications may be combined, within the scope in which such combinations do not contradict from the technical point of view.
It is also possible to use a linear motion conversion mechanism 40 including a nut 42 that moves linearly in accordance with the rotation of a screw shaft 41, as illustrated in FIG. 10. In this structure, the screw shaft 41 corresponds to the rotating member, and the nut 42 corresponds to the linear motion member. With this structure, a piston 43 is pivotably coupled to the nut 42, which is the linear motion member.
As illustrated in FIG. 10, a socket hole 44 having a concave spherical internal surface may be provided in the linear motion member, and a ball head 45 having a convex spherical surface may be provided to the piston 43. With this structure, too, the piston 43 is pivotably coupled to the linear motion member.
The piston may be pivotably coupled to the linear motion member by using a coupling structure other than the ball joint. For example, in FIG. 11, a piston 50 is coupled with a screw shaft 51 that is a linear motion member, via a cylindrical pin 52. The pin 52 passes through a through hole 53 passed through an end of the screw shaft 51. Each end of the pin 52 is fixed to the piston 50. In this manner, the piston 50 is coupled pivotably to the screw shaft 51 about the pin 52. In this structure, too, in order to suppress uneven wearing of the brake pad 15, it is preferable that the piston 50 is enabled to pivot about an axis perpendicular to a plane including the rotation axes A1, A2 of the nut 19 and the brake rotor 18, as a pivot axis. This configuration can be achieved by disposing the center axis A3 of the pin 52 perpendicularly to the plane.
As the decelerator mechanism 12, it is also possible to use a mechanism other than the speed reduction gear mechanism, e.g., a planetary gear mechanism. In addition, the arrangement of the electric motor 11, the decelerator mechanism 12, the linear motion conversion mechanism 13, and the like in the electric braking device 10 may be different from that in FIG. 1. For example, a planetary gear mechanism may be used as the decelerator mechanism 12, and the electric motor 11, the decelerator mechanism 12, and the linear motion conversion mechanism 13 may be arranged serially and coaxially.

1. An electric braking device that generates braking force by pressing friction members against a brake rotor using rotation of an electric motor as power, the electric braking device comprising:
a rotating member that rotates upon receiving rotation of the electric motor;
a linear motion member that linearly moves in accordance with a rotation of the rotating member; and
a piston that is pivotably coupled to the linear motion member and that linearly moves together with the linear motion member to press the friction members against the brake rotor.

2. The electric braking device according to claim 1, wherein the piston maintains contact between the piston and a pressed surface of the friction member, by being pivotably coupled to the linear motion member, the pressed surface being a surface where pressing force of the piston is received.

3. The electric braking device according to claim 1, wherein
one of the linear motion member and the piston has a socket hole that is a spherical hole,
remaining one of the linear motion member and the piston has a ball head that is spherical and that is to be fitted into the socket hole, and
the piston is pivotably coupled to the linear motion member by fitting the ball head into the socket hole.

4. The electric braking device according to claim 3, wherein a cap made of an elastic material is fixed to an opening of the socket hole, and the cap has an annular shape having an inner diameter smaller than a spherical diameter of the ball head.

5. The electric braking device according to claim 1, further comprising a rotation restricting structure that includes a recess provided on one of the linear motion member and the piston, and a protrusion provided on remaining one of the linear motion member and the piston and to be positioned inside the recess, and
the rotation restricting structure, with the recess and the protrusion fitted to each other, restricts a relative rotation of the linear motion member with respect to the piston about a rotation axis of the rotating member, within a predetermined angle.

6. The electric braking device according to claim 2, wherein
one of the linear motion member and the piston has a socket hole that is a spherical hole,
remaining one of the linear motion member and the piston has a ball head that is spherical and that is to be fitted into the socket hole, and
the piston is pivotably coupled to the linear motion member by fitting the ball head into the socket hole.

7. The electric braking device according to claim 2, further comprising a rotation restricting structure that includes a recess provided on one of the linear motion member and the piston, and a protrusion provided on remaining one of the linear motion member and the piston and to be positioned inside the recess, and
the rotation restricting structure, with the recess and the protrusion fitted to each other, restricts a relative rotation of the linear motion member with respect to the piston about a rotation axis of the rotating member, within a predetermined angle.

8. The electric braking device according to claim 3, further comprising a rotation restricting structure that includes a recess provided on one of the linear motion member and the piston, and a protrusion provided on remaining one of the linear motion member and the piston and to be positioned inside the recess, and
the rotation restricting structure, with the recess and the protrusion fitted to each other, restricts a relative rotation of the linear motion member with respect to the piston about a rotation axis of the rotating member, within a predetermined angle.
